(19) United States
(12) Patent Application Publication
(10) Pub. No.: US 2023/0381734 A1
(43) Pub. Date: Nov. 30, 2023

(54) FLOW REACTOR WITH THERMAL CONTROL FLUID PASSAGE HAVING INTERCHANGEABLE WALL STRUCTURES

(71) Applicant: CORNING INCORPORATED, Corning, NY (US)

(72) Inventors: Sylvain Maxime F Gremetz, Varennes sur Seine (FR); Elena Daniela Lavric, Avon (FR)

(21) Appl. No.: 18/028,271

(22) PCT Filed: Sep. 22, 2021
(86) PCT No.: PCT/US2021/051400

§ 371 Date: Mar. 24, 2023

Related U.S. Application Data
(60) Provisional application No. 63/086,047, filed on Sep. 30, 2020.

(51) Int. Cl. B01J 19/00; F28F 21/04; F28D 9/00; F28F 3/12

(52) U.S. Cl. CPC B01J 19/0093; F28F 21/04; F28D 9/0037; F28F 3/12; F28D 2021/0022

(57) ABSTRACT

A flow reactor includes a flow reactor module having a heat exchange fluid enclosure with an inner surface sealed against a surface of a process fluid module, the inner surface having two or more grooves therein extending in a second direction at least partially crosswise to the first direction, at least two of the two or more grooves each having positioned therein a respective wall extending both into the respective groove and out of the respective groove beyond the inner surface.

### CROSS-REFERENCE TO RELATED APPLICATIONS

This application claims the benefit of priority under 35 U.S.C. § 119 of U.S. Provisional Application No. 63/086,047, filed Sep. 30, 2020, the content of which is incorporated herein by reference in its entirety.

### FIELD

The disclosure relates generally to apparatuses and methods for flow reactors and flow reaction processing, more specifically to flow reactors comprising (1) a central body or process fluid module having a passage therethrough, first and second major external surfaces and (2) first and second thermal control fluid passages in thermal contact with the first and second major external surfaces, respectively, and with pump or pumps for supply of a thermal control fluid to the thermal control fluid passages. The disclosure relates more specifically to a flow reactor with a thermal control fluid passage having interchangeable wall structures therein.

### BACKGROUND

High performance process fluid modules for flow reactors have been formed from ceramic materials, particularly silicon carbide, desirably for its very high chemical resistance, high mechanical strength, and reasonably high thermal conductivity. Where the highest chemical durability is not required and lower thermal conductivity is permissible, stainless steel is an attractive alternative. Where thermal control of reaction processes is needed, one solution has been use of a generally planar process fluid module 10 as shown in FIG. 1, having two major outer surfaces 12, 14, such as a process fluid module comprised of two plates of silicon carbide or stainless steel joined temporarily or permanently and containing a process fluid passage P defined between the halves, together with heat exchange enclosures 16, 18 as shown in FIG. 2, sealed to each of the two major surfaces 12, 14 and defining, in cooperation with the respective major surfaces, a heat exchange fluid passage HP in contact with the respective major surface. Small protuberances or “turbulators” (not shown) on an inner surface of such heat exchange enclosures have been used to increase turbulence and/or secondary flows in heat exchange fluid flowing through heat exchange fluid passages.

### SUMMARY

According to embodiments, a flow reactor includes a flow reactor module having a heat exchange fluid enclosure with an inner surface sealed against a surface of a process fluid module, the inner surface having two or more grooves therein extending in a second direction at least partially crosswise to the first direction, at least two of the two or more grooves each having positioned therein a respective wall extending both into the respective groove and out of the respective groove beyond the inner surface.

According to embodiments, the flow reactor module can comprise or be formed or constituted of a ceramic. According to embodiments, the ceramic can comprise or be silicon carbide. According to embodiments, the flow reactor module can comprise or be formed or constituted of stainless steel.

According to embodiments, the flow reactor module can monolithic, that is, one body formed as single piece, or if formed from multiple pieces, then formed from multiple pieces permanently joined together so as to be inseparable except by cutting, grinding, or fracturing the module, or the like.

According to embodiments, the first and second heat exchange fluid enclosures can comprise or be formed principally or wholly of a metal.

According to embodiments, the interior surface of the first heat exchange fluid enclosure comprises three or more grooves.

According to embodiments, a distance between walls and a gap between walls and a surface of the process fluid module can be selected to maximize, to within 80% of a maximum achievable, an average Reynolds number within the heat exchange fluid path within a selected heat exchange fluid and using a selected heat exchange pump power for pumping the heat exchange fluid.

Additional embodiments and various advantages will be apparent from the description, figures, and claims below.

### BRIEF DESCRIPTION OF THE DRAWINGS

FIG. 1 is a diagrammatic perspective view of a process fluid module.

FIG. 2 is a diagrammatic elevational view of a fluidic module including a process fluid module and heat exchange enclosures.

FIG. 3 is perspective view showing a process fluid module with detail of an embodiment of an (interior) process fluid path.

FIG. 4 is a perspective view of an embodiment of a heat exchange enclosure.

FIGS. 5-7 are plan views of embodiments of heat exchanger enclosures with grooves according to the present disclosure.

FIG. 8 is a view of a flow reactor module, according to embodiments of the present disclosure, including cross-sectional views of heat exchanger enclosures together with a process fluid module.

FIG. 9 is a graph of relative Reynolds numbers (Re) obtained within a heat exchange fluid path with a particular heat exchange fluid at a particular pump power as a function of gap (Ga) for three different distances D (decreasing in the direction of the arrow), showing that the Reynolds number can be optimized for a given pump power and heat exchange fluid by adjusting (decreasing) the distance D and adjusting (enlarging beyond that required for clearance) the gap Ga.

### DETAILED DESCRIPTION

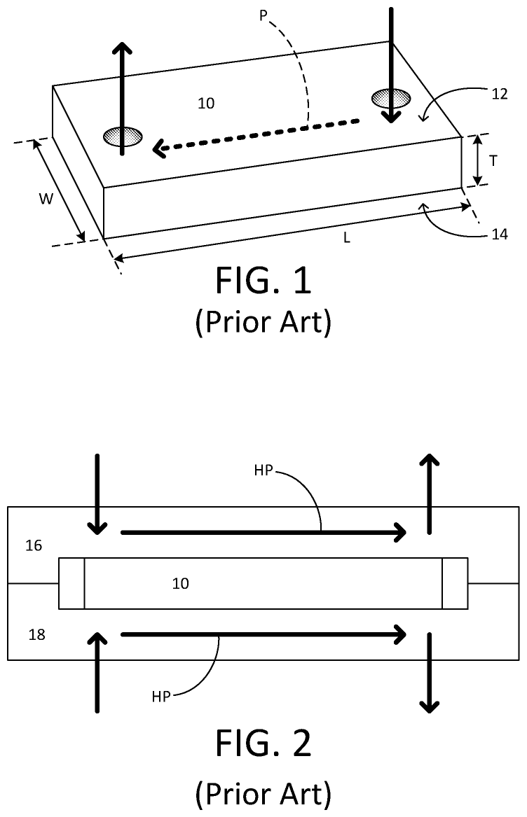

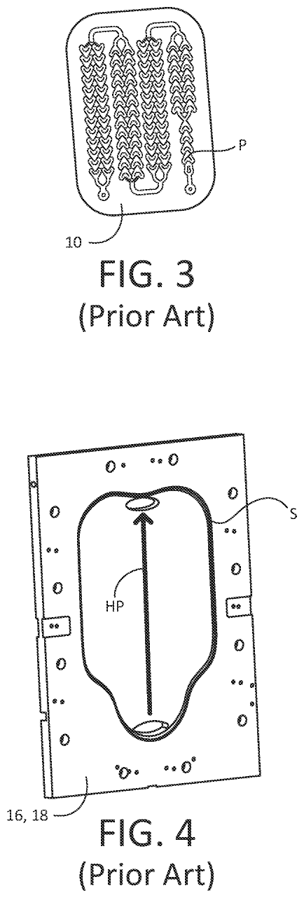

FIGS. 1 and 2 are discussed above. FIG. 3 shows a perspective view of a process fluid module 10 with detail of an embodiment of an (interior) process fluid path P, such as may be used in the context of the present disclosure. FIG. 4 shows a perspective view of an embodiment of a heat exchange enclosure of a general shape which is one shape envisioned for use with the present disclosure.

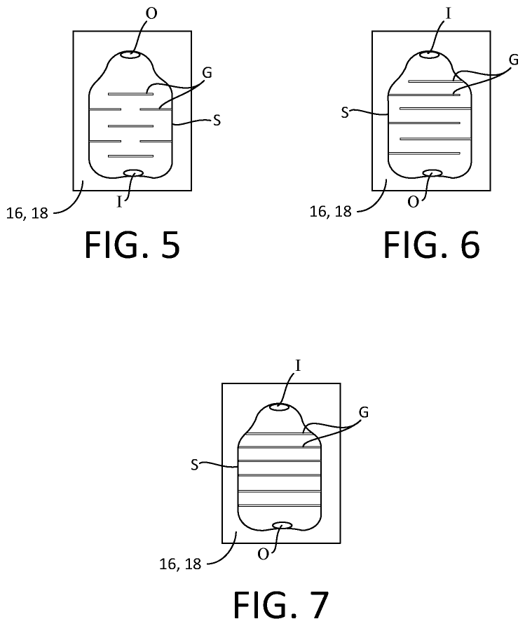

The present disclosure departs from these prior art structures as shown particularly in FIGS. 5-7. According to one aspect of the present disclosure, with particular reference to FIGS. 5-7, grooves G interior surfaces 17, 19 of heat exchange enclosures 16, 18. The grooves G are positioned to be able to hold walls which can serve as baffles within the region bounded by a seal S (such as an O-ring or other seal). The ridges may take various configurations as seen in the embodiments of FIGS. 5-7. Common across all embodiments is that the grooves G number at least two, and that the ridges G extend in a direction (a second direction) at least partially crosswise to a first direction from an inflow port or location I to an outflow port or location O.

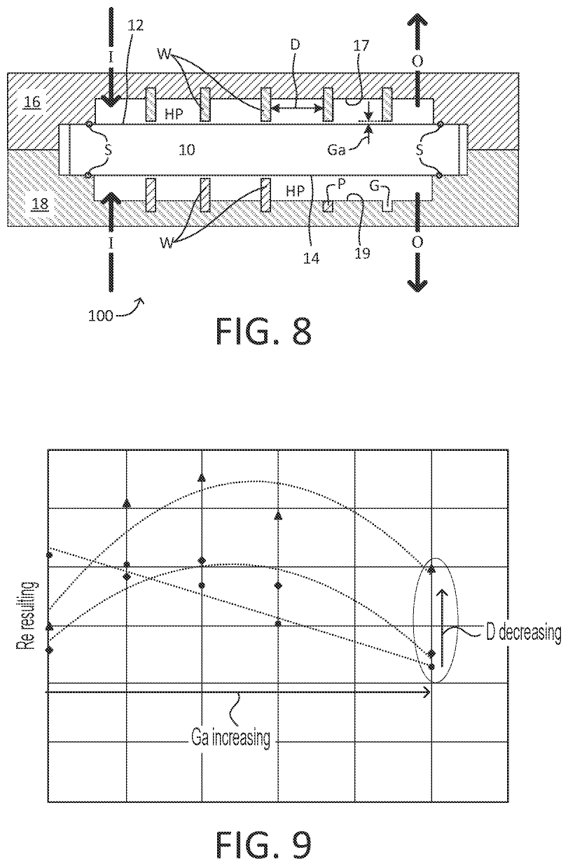

As seen with reference to FIG. 8, according to another aspect of the present disclosure, at least two of the two or more grooves Gin interior surface 17 each have positioned therein a respective wall W extending both into the respective groove G and out of the respective groove G beyond the interior surface 17. There can optionally be a gap Ga between two or more walls W and the first major surface 12 of the process fluid module 10. This gap Ga can be desirable in that it provides protection from induced marring or induced stress in the structure of the embodiments of process fluid module 10 which are ceramic. However, according to the present disclosure, the gap Ga can desirably be intentionally larger than needed to provide reliable mechanical separation between the respective major surfaces 12, 14 of the process fluid module 10 and the walls W (larger than 0.1 mm, for example). This is because heat exchange performance can be optimized, for a given heat exchange fluid and a given pump power, by making the gap larger than necessary for mechanical separation, but not so large as to lower the heat exchange, as illustrated below with respect to FIG. 9. Although the gap can be non-existent or 0 mm, particularly for metal process fluid modules 10, it is desirably 0.1 mm or greater, desirably greater than 0.2 mm or even greater than 0.3 mm or 0.4 mm, while remaining small enough such that the walls W still divert a large amount of flow, such as smaller than 1 mm, desirably smaller than 0.9 mm, than 0.8 mm, than 0.7 mm, than 0.6 mm, than 0.5 mm, or even in appropriate cases than 0.4 mm. The walls W as shown in FIG. 8 can be interchanged or replaced by users to adjust the gap G (or even to provide different gaps G at different locations in one flow reactor module 100. As also shown in FIG. 8, according to one alternative for embodiments of the flow reactor module, plugs P can be located or positioned within one or more grooves G to prevent fluid dead space at locations where grooves G exist but no wall height is desired.

FIG. 9 is a graph of relative Reynolds numbers (Re, on the y axis) obtained within a heat exchange fluid path with selected heat exchange fluid at a selected maximum pump power as a function of gap Ga (on the x axis) for three different distances D (decreasing in the direction of the arrow). This graph shows that the Reynolds number (and accordingly heat exchange performance) in the heat exchange fluid path HP can be optimized for a given pump power and heat exchange fluid by adjusting (decreasing) the distance D and adjusting (enlarging beyond that required for mechanical clearance) the gap Ga. Desirably, the distance (D) and the gap (Ga) can be selected to maximize within to within 80%, 90% or even 95% of maximum possible, an average Reynolds number within the heat exchange fluid path (HP) within a selected heat exchange fluid and a selected heat exchange pump power for pumping the heat exchange fluid.

The methods and/or devices disclosed herein are generally useful in performing any process that involves mixing, separation including reactive separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formylation; phase transfer reactions; silylations; nitrile synthesis; phosphorylation; ozonolysis; azide chemistry; metathesis; hydrosilylation; coupling reactions; and enzymatic reactions.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A flow reactor, comprising
a flow reactor module; the flow reactor module comprising:
a process fluid module with a process fluid passage extending therethrough, the process fluid module comprising an extended body having a width, a length, and a thickness, the thickness being less than the length and less than the width, the process fluid module having first and second major surfaces on opposite sides of the process fluid module, oriented perpendicularly to a direction of the thickness of the process fluid module;
a first heat exchange fluid enclosure sealed against the first major surface of the process fluid module, the first heat exchange fluid enclosure comprising an interior surface of the first heat exchange fluid enclosure for containing heat exchange fluid against the first major surface to form a heat exchange fluid path of the first heat exchange fluid enclosure for the heat exchange fluid, and an inflow port of the first heat exchange fluid enclosure for delivering heat exchange fluid to the heat exchange fluid path of the first heat exchange fluid enclosure and an outflow port or location of the first heat exchange fluid enclosure for receiving heat exchange fluid from the heat exchange fluid path of the first heat exchange fluid enclosure, the outflow port of the first heat exchange fluid enclosure spaced from the inflow port of the first heat exchange fluid enclosure in a first direction; and
a second heat exchange fluid enclosure sealed against the second major surface of the process fluid module, the second heat exchange fluid enclosure comprising an interior surface of the second heat exchange fluid enclosure for containing heat exchange fluid against the second major surface to form the heat exchange fluid path of the second heat exchange fluid enclosure for heat exchange fluid, and an inflow port of the second heat exchange fluid enclosure for delivering heat exchange fluid to the heat exchange fluid path of the second heat exchange fluid enclosure and an outflow port of the second heat exchange fluid enclosure for receiving heat exchange fluid from the heat exchange fluid path of the second heat exchange fluid enclosure;
wherein the interior surface of the first heat exchange fluid enclosure has two or more grooves therein extending in a second direction at least partially crosswise to the first direction, at least two of the two or more grooves each having positioned therein a respective wall extending both into the respective groove and out of the respective groove beyond the interior surface of the first heat exchange fluid enclosure.

2. The flow reactor of claim 1, wherein the inner surface of the second heat exchange fluid enclosure also has two or more grooves therein extending in a second direction at least partially crosswise to the first direction, at least two of the two or more grooves each having positioned therein a respective wall extending both into the respective groove and out of the respective groove beyond the surface.

3. The flow reactor of claim 1 wherein there is a gap between the respective wall(s) of the two or more grooves of the interior surface of the first heat exchange fluid enclosure and the first major surface of the process fluid module.

4. The flow reactor of claim 3 wherein the gap is in the range of from 0 to 1 mm.

5. The flow reactor of claim 3 wherein the gap is in the range of from 0.2 to 0.5 mm.

6. The flow reactor of claim 1, wherein the process fluid module comprises a ceramic.

7. The flow reactor according to of claim 6, wherein the ceramic comprises silicon carbide.

8. The flow reactor of claim 1, wherein the process fluid module comprises stainless steel.

9. The flow reactor of claim 1, wherein the first and second heat exchange fluid enclosures comprise a metal.

10. The flow reactor of claim 3, wherein the gap are selected to maximize within to within 80% of maximum an average Reynolds number within the heat exchange fluid path for a selected heat exchange fluid and a selected heat exchange pump power.

11. A flow reactor, comprising
a flow reactor module; the flow reactor module comprising:
a process fluid module with a process fluid passage extending therethrough, the process fluid module comprising an extended body having a width, a length, and a thickness, the thickness being less than the length and less than the width, the process fluid module having first and second major surfaces on opposite sides of the process fluid module, oriented perpendicularly to a direction of the thickness of the process fluid module;
a first heat exchange fluid enclosure sealed against the first major surface of the process fluid module, the first heat exchange fluid enclosure comprising an interior surface of the first heat exchange fluid enclosure for containing heat exchange fluid against the first major surface to form a heat exchange fluid of the first heat exchange fluid enclosure for the heat exchange fluid, and an inflow port of the first heat exchange fluid enclosure for delivering heat exchange fluid to the heat exchange fluid path of the first heat exchange fluid enclosure and an outflow port of the first heat exchange fluid enclosure for receiving heat exchange fluid from the heat exchange fluid path of the first heat exchange fluid enclosure, the outflow port of the first heat exchange fluid enclosure spaced from the inflow port of the first heat exchange fluid enclosure in a first direction; and
wherein the interior surface of the first heat exchange fluid enclosure has two or more grooves therein extending in a second direction at least partially crosswise to the first direction, at least two of the two or more grooves each having positioned therein a respective wall extending both into the respective groove and out of the respective groove beyond the interior surface of the first heat exchange fluid enclosure.

12. The flow reactor of claim 11 wherein there is a gap between the respective wall(s) of the two or more grooves of the interior surface of the first heat exchange fluid enclosure and the first major surface of the process fluid module.

13. The flow reactor of claim 12, wherein the gap are selected to maximize within to within 80% of maximum an average Reynolds number within the heat exchange fluid path for a selected heat exchange fluid and a selected heat exchange pump power.

14. A flow reactor, comprising
a flow reactor module; the flow reactor module comprising:
a process fluid module with a process fluid passage extending therethrough, the process fluid module comprising an extended body having a width, a length, and a thickness, the thickness being less than the length and less than the width, the process fluid module having first and second major surfaces on opposite sides of the process fluid module, oriented perpendicularly to a direction of the thickness of the process fluid module;
a first heat exchange fluid enclosure sealed against the first major surface of the process fluid module, the first heat exchange fluid enclosure comprising an interior surface of the first heat exchange fluid enclosure for containing heat exchange fluid against the first major surface to form a heat exchange fluid of the first heat exchange fluid enclosure for the heat exchange fluid, and an inflow port of the first heat exchange fluid enclosure for delivering heat exchange fluid to the heat exchange fluid path of the first heat exchange fluid enclosure and an outflow port of the first heat exchange fluid enclosure for receiving heat exchange fluid from the heat exchange fluid path of the first heat exchange fluid enclosure, the outflow port of the first heat exchange fluid enclosure spaced from the inflow port of the first heat exchange fluid enclosure in a first direction; and
a second heat exchange fluid enclosure sealed against the second major surface of the process fluid module, the second heat exchange fluid enclosure comprising an interior surface of the second heat exchange fluid enclosure for containing heat exchange fluid against the second major surface to form the heat exchange fluid path of the second heat exchange fluid enclosure for heat exchange fluid, and an inflow port of the second heat exchange fluid enclosure for delivering heat exchange fluid to the heat exchange fluid path of the second heat exchange fluid enclosure and an outflow port of the second heat exchange fluid enclosure for receiving heat exchange fluid from the heat exchange fluid path of the second heat exchange fluid enclosure;
wherein the interior surface of the first heat exchange fluid enclosure has two or more walls extending both into beyond the interior surface of the first heat exchange fluid enclosure and into the heat exchange fluid path of the first heat exchange fluid enclosure.

15. The flow reactor of claim 14 wherein there is a gap between the respective wall(s) of the interior surface of the first heat exchange fluid enclosure and the first major surface of the process fluid module.

16. The flow reactor of claim 15, wherein the gap is selected to maximize within to within 80% of maximum an average Reynolds number within the heat exchange fluid path for a selected heat exchange fluid and a selected heat exchange pump power.
